(19) United States
(12) Patent Application Publication
(10) Pub. No.: US 2019/0063798 A1
(43) Pub. Date: Feb. 28, 2019

(54) TEMPERATURE CONTROL SYSTEM FOR CRYOGENIC TISSUE EMBEDDING

(71) Applicant: THE FIRST HOSPITAL OF CHINA MEDICIAL UNIVERSITY, Shenyang (CN)

(72) Inventors: Ruiqun Qi, Shenyang (CN); Xinghua Gao, Shenyang (CN); Hong-Duo Chen, Shenyang (CN)

(21) Appl. No.: 15/924,228

(22) Filed: Mar. 18, 2018

(30) Foreign Application Priority Data
Aug. 30, 2017 (CN) 201710759885.7

(51) Int. Cl. F25B 21/04; G05B 15/02

(52) U.S. Cl. CPC F25B 21/04; F25B 2321/021; G05B 15/02

(57) ABSTRACT

A temperature control system for cryogenic tissue embedding belongs to the technical field of cryogenic tissue embedding of biological samples, which in particular relates to a temperature control system for cryogenic tissue embedding. The present invention provides a temperature control system for cryogenic tissue embedding with high operation efficiency and good use effects. The present invention comprises a heating and cooling semiconductor element and a control circuit. A control signal output port of the control circuit is connected to a control signal input port of the heating and cooling semiconductor element, and a detection signal input port of the control circuit is connected to a detection signal output port of a temperature sensor that detects the temperature of the heating and cooling semiconductor element. The control circuit comprises a CPU, a power conversion part, a system control part, a memory, a system feedback part, a display part, a Bluetooth part, and a heat-dissipation control part. A control signal output port of the CPU is connected to a control signal input port of the system control part and a control signal input port of the heat-dissipation control part, respectively.

### TECHNICAL FIELD

The present invention belongs to the technical field of cryogenic tissue embedding of biological samples, and in particular, to a temperature control system for cryogenic tissue embedding.

### BACKGROUND ART

The patented technology in Chinese Patent No. 201610159556.4 proposes an embedded embedding solution in the aspect of cryogenic biological sample storage, by which the cryogenic biological sample embedding technology saves lots of time, improves the operation efficiency, saves plenty of storage space, and implements automated batch scan and storage.

The foregoing technology resolves the problem of batch sample storage, but in a subsequent use process, an embedded label needs to be thawed and refrozen. In a conventional operation process, the researcher generally performs a thawing operation with the body temperature and a freezing operation in a frigid environment of a refrigerator. This process is time-consuming and laborsome, and does not facilitate batch operations. In addition, if the thawing or refreezing process lasts long, nucleic acid or protein information of an embedded biological sample may be further affected.

### SUMMARY

In view of the foregoing problem, the present invention provides a temperature control system for cryogenic tissue embedding with high operation efficiency and good use effects.

To achieve the foregoing objective, the present invention uses the following technical solution: the present invention comprises a housing, wherein a housing base is provided with a semiconductor element limit slot, a heating and cooling semiconductor element is disposed in the semiconductor element limit slot, an upper end of the semiconductor element limit slot is covered by an embedding block limit plate, and an embedding block limit hole is disposed on the embedding block limit plate and corresponds to the semiconductor element limit slot; and a control circuit disposed in the housing base, wherein a control signal output port of the control circuit is connected to a control signal input port of the heating and cooling semiconductor element, and a detection signal input port of the control circuit is connected to a detection signal output port of a temperature sensor that detects the temperature of the heating and cooling semiconductor element.

The control circuit comprises a CPU, a power conversion part, a system control part, a memory, a system feedback part, a display part, a Bluetooth part, and a heat-dissipation control part, wherein a control signal output port of the CPU is connected to a control signal input port of the system control part and a control signal input port of the heat-dissipation control part, respectively, a detection signal input port of the CPU is connected to a detection signal output port of the system feedback part, a signal transmission port of the CPU is connected to a signal transmission port of the memory, a signal transmission port of the display part, and a signal transmission port of the Bluetooth part, respectively; and the display part is disposed in the front of the housing.

A power supply output port of the power conversion part is connected to a power port of the CPU, a power port of the system control part, a power port of the memory, a power port of the system feedback part, a power port of the display part, a power port of an alarm part, and a power port of the heat-dissipation control part, respectively.

As a preferred solution, in the present invention, the heating and cooling semiconductor element is a two-level heating and cooling semiconductor element.

As another preferred solution, in the present invention, the semiconductor element limit slot is disposed on the semiconductor element limit plate, and the semiconductor element limit plate is detachably connected to the housing base; the semiconductor element limit slot comprises a strip groove extending from an edge of the semiconductor element limit plate to the central portion, an upper portion of two ends of the groove is a first protrusion facing the central portion, a limit stop is disposed on a lower end of the semiconductor element limit plate on an inner end of the groove, a lower bearing plate is disposed below an inner side of the groove, and two sides of the lower bearing plate are connected to the lower end of the semiconductor element limit plate; an upper portion on an inner side of the first protrusion is a second protrusion facing the central portion; and a bearing guide plate is disposed on an opening edge of the housing base where the semiconductor element limit plate is mounted, and corresponds to an initial placement position of a first-level heating and cooling semiconductor element of the two-level heating and cooling semiconductor element.

As another preferred solution, in the present invention, the semiconductor element limit plate is provided with four semiconductor element limit slots, and centers of the four semiconductor element limit slots form a square when being connected; and the embedding block limit plate is provided with four embedding block limit holes corresponding to the semiconductor element limit slots.

As another preferred solution, in the present invention, a cover plate for tightly pressing a tissue sample embedding block in the embedding block limit hole is further provided, an upper cover is disposed on an upper end of the housing, one end of the upper cover is axially connected to the housing, and the other end of the upper cover is engaged with the housing.

As another preferred solution, in the present invention, the CPU is an STM32F103RBT6 chip U1, wherein a pin 5 of U1 is connected to one end of a resistor R1, one end of a crystal oscillator X1, and one end of a capacitor C1, respectively, a pin 6 of U1 is connected to the other end of the resistor R1, the other end of the crystal oscillator X1, and one end of a capacitor C2, respectively, the other end of the capacitor C1 is connected to a ground wire, the other end of the capacitor C2, and one end of a capacitor C3, respectively, the other end of the capacitor C3 is connected to one end of a resistor R2 and a pin 7 of U1, respectively, and the other end of the resistor R2 is connected to a 3.3-V power supply; a pin 60 of U1 is grounded by using a resistor R3, a pin 38 of U1 is connected to a cathode of a light emitting diode DS1, an anode of the light emitting diode DS1 is connected to the 3.3-V power supply by using a resistor RD1, a pin 37 of U1 is connected to a cathode of a light emitting diode DS0, and an anode of the light emitting diode DS0 is connected to the 3.3-V power supply by using a resistor RD2.

As another preferred solution, in the present invention, the power conversion part comprises an LM2596S-5.0 chip U2 and an RT9167A-3.3 chip U3, wherein a pin 1 of U2 is connected to a cathode of a diode D1 and an anode of a capacitor C8, respectively, an anode of the diode D1 is connected to a 15-V power supply and an anode of a capacitor C12, respectively, and a cathode of the capacitor C12 is connected to a cathode of the capacitor C8 and a ground wire, respectively; a pin 2 of U2 is connected to a cathode of a diode D2 and one end of an inductor L1, respectively, an anode of the diode D2 is grounded, the other end of the inductor L1 is connected to an anode of a capacitor C9, a pin 4 of U2, an anode of a capacitor C10, an anode of a capacitor C11, and a power supply VCC, respectively, and pins 3 and 5 of U2 are grounded.

Pins 1 and 3 of U3 are connected to the power supply VCC; a pin 2 of U3 is grounded; a pin 4 of U3 is grounded by using a capacitor C17; a pin 5 of U3 is connected to one end of a capacitor C18, an anode of a capacitor C19, an anode of a capacitor C20, and the 3.3-V power supply, respectively; and the other end of the capacitor C18 is connected to a cathode of the capacitor C19, the cathode of the capacitor C20, and a ground wire, respectively.

As another preferred solution, in the present invention, the system control part comprises an IRF740 chip MOS2, an IRF740 chip MOS1, an IRF740 chip MOS3, an IRF740 chip MOS4, a relay SRD1, a relay SRD2, a relay SRD3, a relay SRD4, and a ULN2003 chip U4, wherein a pin 5 of the relay SRD1 is connected to GND_P1, a pin 4 of the relay SRD1 is connected to 15V_P1, a pin 1 of the relay SRD1 is connected to the power supply VCC, a pin 3 of the relay SRD1 is connected to a pin 14 of U4, and a pin 2 of the relay SRD1 is connected to a pin of the first-level heating and cooling semiconductor element of the two-level heating and cooling semiconductor element.

A pin 5 of the relay SRD2 is connected to GND_P1, a pin 4 of the relay SRD2 is connected to 15V_P1, a pin 1 of the relay SRD2 is connected to the power supply VCC, a pin 3 of the relay SRD2 is connected to a pin 13 of U4, and a pin 2 of the relay SRD2 is connected to another pin of the first-level heating and cooling semiconductor element of the two-level heating and cooling semiconductor element.

A pin 5 of the relay SRD3 is connected to GND_P2, a pin 4 of the relay SRD3 is connected to 15V_P2, a pin 1 of the relay SRD3 is connected to the power supply VCC, a pin 3 of the relay SRD3 is connected to a pin 16 of U4, and a pin 2 of the relay SRD3 is connected to a pin of a second-level heating and cooling semiconductor element of the two-level heating and cooling semiconductor element.

A pin 5 of the relay SRD4 is connected to GND_P2, a pin 4 of the relay SRD4 is connected to 15V_P2, a pin 1 of the relay SRD4 is connected to the power supply VCC, a pin 3 of the relay SRD4 is connected to a pin 15 of U4, and a pin 2 of the relay SRD4 is connected to another pin of the second-level heating and cooling semiconductor element of the two-level heating and cooling semiconductor element.

The 15-V power supply is connected to 15V_P1 by using a thermal protection switch PROTECT1, and the 15-V power supply is connected to 15V_P2 by using a thermal protection switch PROTECT2.

A pin 2 of MOS2 is connected to GND_P1 and a pin 2 of MOS1, respectively, a pin 1 of MOS2 is connected to a pin 9 of U1, a pin 1 of MOS1, and one end of a resistor R7, respectively, the other end of the resistor R7 is connected to the 15-V power supply, and a pin 3 of MOS1 and a pin 3 of MOS2 are grounded.

A pin 2 of MOS3 is connected to GND_P2 and a pin 2 of MOS4, respectively, a pin 1 of MOS3 is connected to a pin 8 of U1, a pin 1 of MOS4, and one end of a resistor R6, respectively, the other end of the resistor R6 is connected to the 15-V power supply, and a pin 3 of MOS4 and a pin 3 of MOS3 are grounded.

Pins 1, 2, 3, 4, and 5 of U4 are correspondingly connected to pins 54, 53, 52, 51, and 50 of U1, respectively, and a pin 12 of U4 is connected to a buzzer BUZ.

In addition, in the present invention, the system feedback part comprises a resistor R10, a resistor R11, and a resistor R13, wherein one end of the resistor R10 is connected to one end of the resistor R11 and one end of the resistor R13, respectively, the other end of the resistor R10 is connected to a temperature sensor that detects the temperature of the first-level heating and cooling semiconductor element, a pin 14 of U1, and one end of the capacitor C13, respectively, and the other end of the capacitor C13 is grounded.

The other end of the resistor R11 is connected to a temperature sensor that detects the temperature of the second-level heating and cooling semiconductor element, a pin 15 of U1, and one end of a capacitor C14, respectively, and the other end of the capacitor C4 is grounded.

The other end of the resistor R13 is connected to a temperature sensor that detects the temperature of a heat sink, a pin 24 of U1, and one end of a capacitor C15, respectively, and the other end of the capacitor C15 is grounded.

In addition, in the present invention, the display part comprises an MAX232 chip U6, wherein a pin 1 and a pin 3 of U6 are connected by using a capacitor C4, a pin 4 and a pin 5 of U6 are connected by using a capacitor C5, a pin 11 of U6 is connected to a pin 42 of U1, a pin 12 of U6 is connected to a pin 43 of U1, a pin 13 of U6 is connected to an RS232RXD pin of an LCD, and a pin 14 of U6 is connected to an RS232TXD pin of the LCD.

The heat-dissipation control part comprises an AO3401 chip MOS5, wherein a pin 1 of MOS5 is connected to one end of a resistor R8 and the 15-V power supply, respectively, the other end of the resistor R8 is connected to one end of a resistor R9 and a pin 2 of MOS5, respectively, a pin 3 of MOS5 is connected to a cooling fan, and the other end of the resistor R9 is connected to the control signal output port of the CPU.

The present invention has the following beneficial effects:

The present invention is an adapter that fits freezing and thawing processes during use of cryogenic embedding tissue.

In the present invention, the heating and cooling semiconductor element is used, which achieves a fast speed and high efficiency in heating and cooling.

In the present invention, the embedding block limit hole is provided, which can effectively prevent a cover of an embedding cassette from sliding and deflecting.

By means of the present invention, a process can be standardized, thereby reducing differentiation interference caused by human factors to a sample and a test process.

The present invention protects biological information of samples well, and avoids a destructive effect during conventional processing.

In the present invention, a plurality of actually tested programs or modes can be set in the control circuit for convenient use.

In the present invention, for a special shape of a “identity carrying element of cryogenic storage system”, a temperature intervention kit matured in exploration is provided, which can separately implement element disassociation and combination operations at −20, −40, and −80 degrees Celsius while fully maintaining a storage temperature of a biological sample.

The control circuit of the utility model facilitates precise control and state display of the heating and cooling semiconductor element, thereby improving the operation efficiency and use effects of the apparatus.

### BRIEF DESCRIPTION OF THE DRAWINGS

The present invention is further described below with reference to the accompanying drawings and detailed description. The protection scope of the present invention is not limited to the description of the following content.

FIG. 1 is a schematic structural diagram of the present invention;

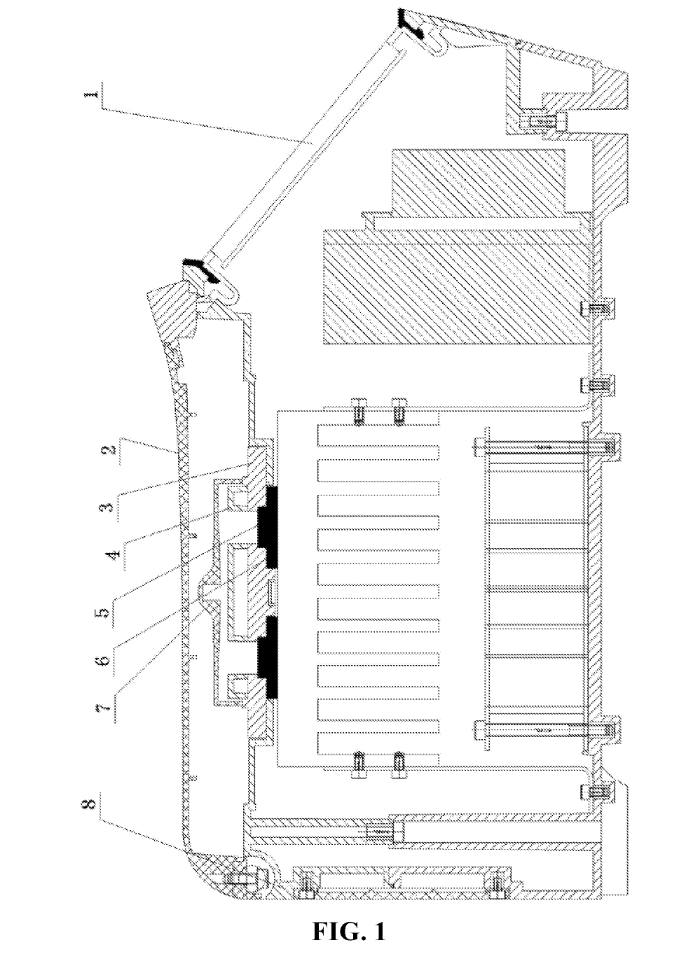

FIG. 2 is a bottom view of a semiconductor element limit plate according to the present invention;

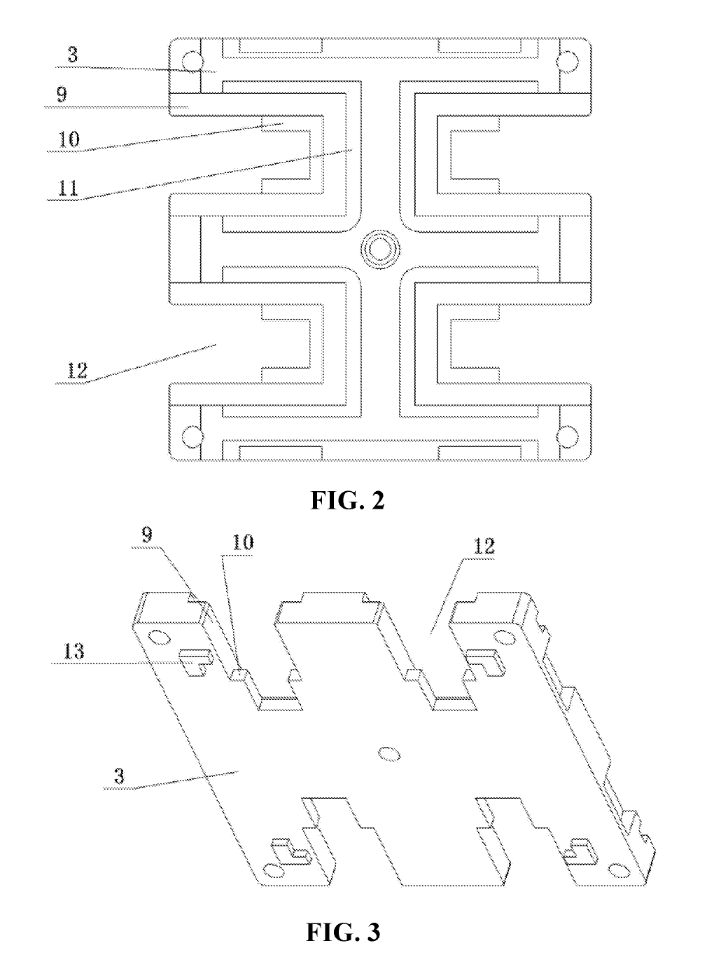

FIG. 3 is a schematic structural diagram of a semiconductor element limit plate according to the present invention;

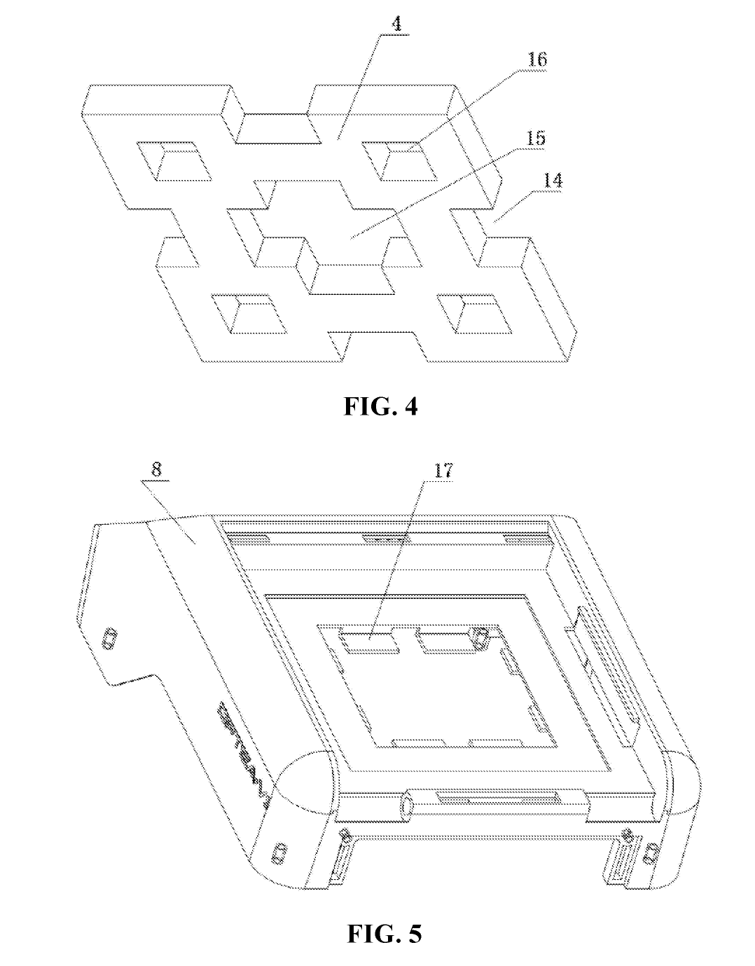

FIG. 4 is a schematic structural diagram of an embedding block limit plate according to the present invention;

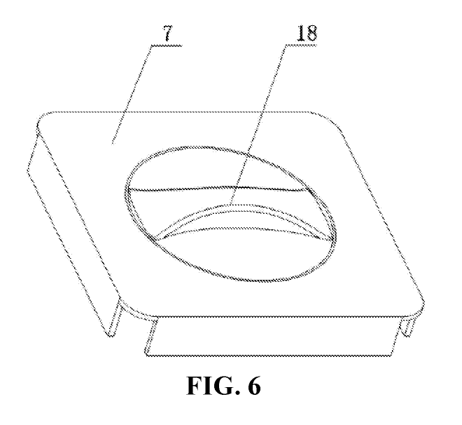

FIG. 5 is a schematic diagram of a position where a bearing guide plate is disposed according to the present invention;

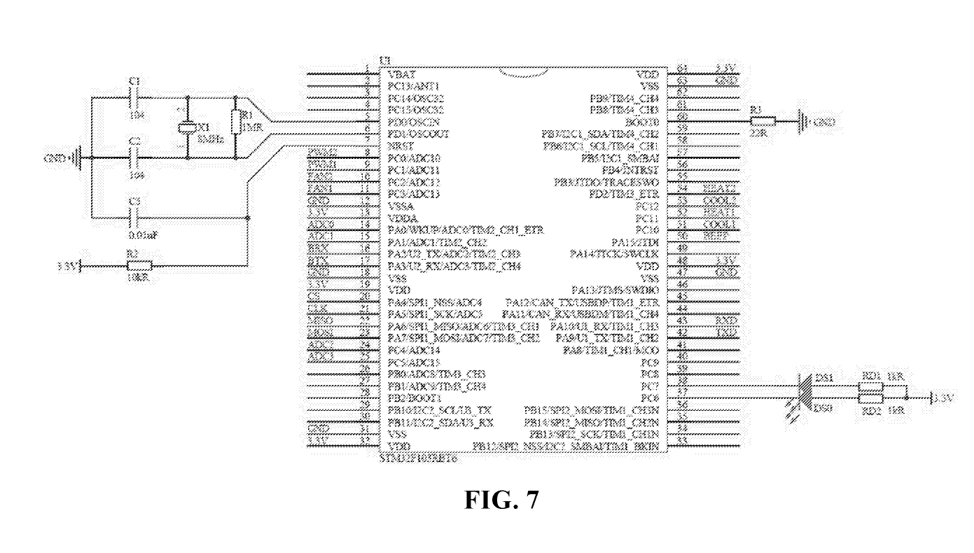

FIG. 6 is a schematic structural diagram of a cover plate according to the present invention;

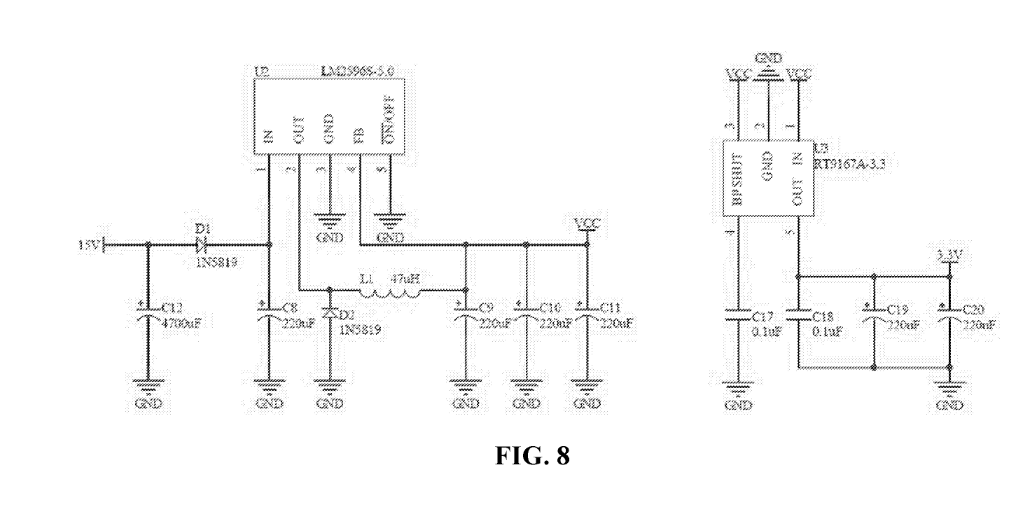

FIG. 7 is a schematic circuit diagram of a CPU part according to the present invention;

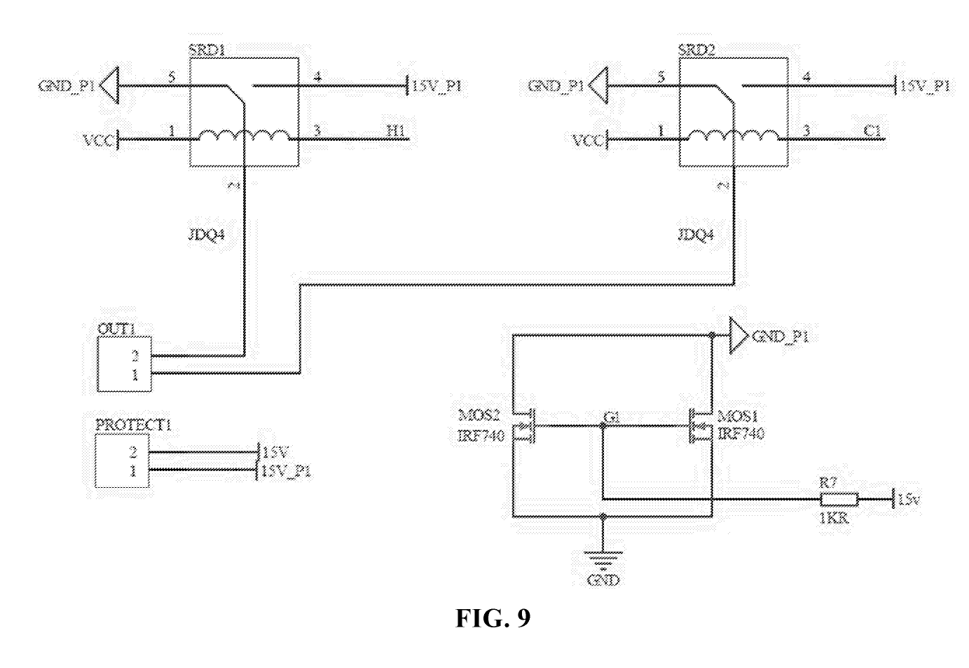

FIG. 8 is a schematic circuit diagram of a power conversion part according to the present invention;

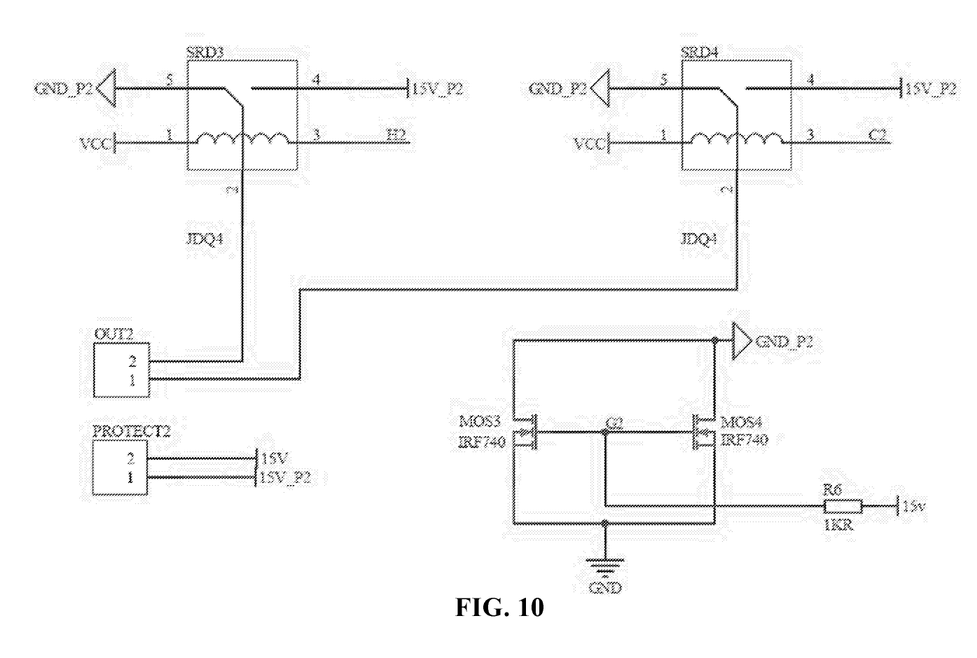

FIGS. 9, 10, and 11 are schematic diagrams of a system control part according to the present invention;

FIG. 12 is a schematic circuit diagram of a memory part according to the present invention;

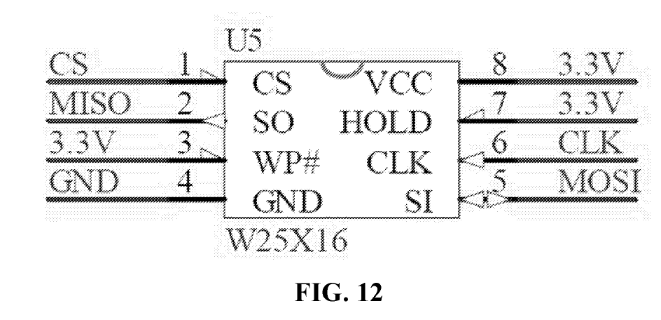

FIGS. 13 and 14 are schematic circuit diagrams of a system feedback part according to the present invention;

FIG. 15 is a schematic circuit diagram of a display part according to the present invention;

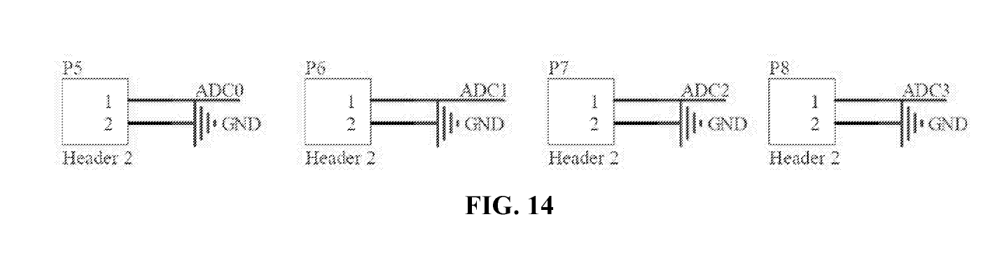

FIG. 16 is a schematic circuit diagram of a Bluetooth part according to the present invention; and

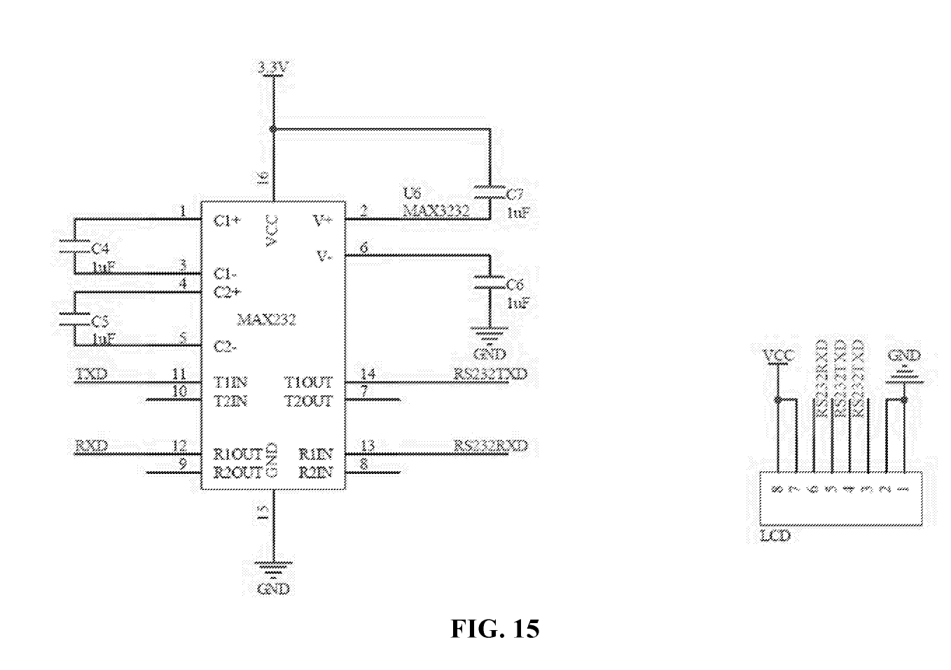

FIG. 17 is a schematic circuit diagram of a heat dissipation part according to the present invention.

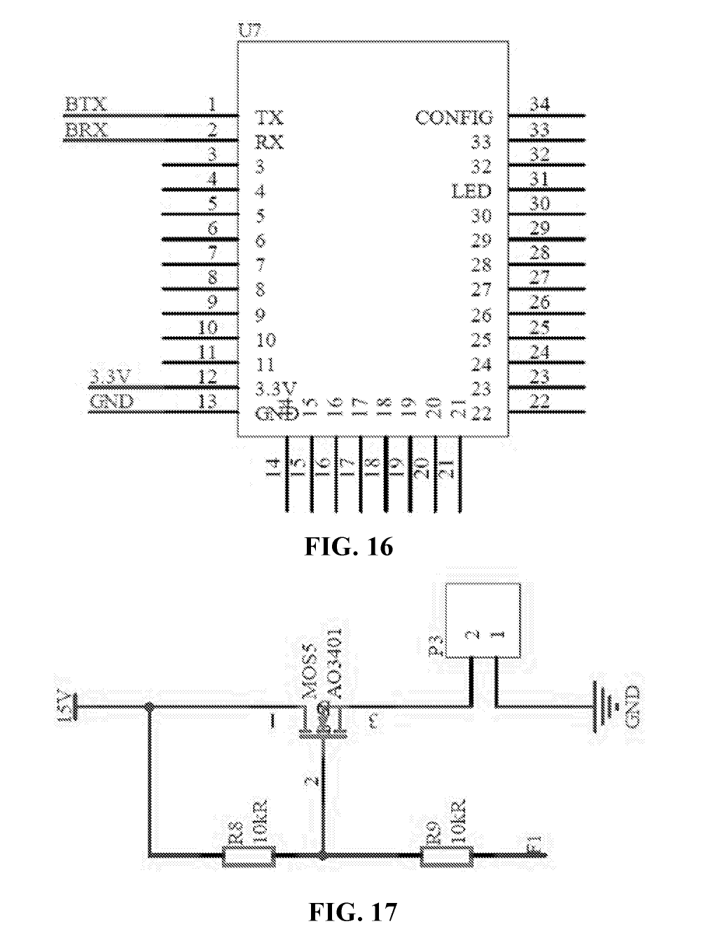

In the figures, 1 represents a display part, 2 represents an upper cover, 3 represents a semiconductor element limit plate, 4 represents an embedding block limit plate, 5 represents a second-level heating and cooling semiconductor element, 6 represents a first-level heating and cooling semiconductor element, 7 represents a cover plate, 8 represents a housing, 9 represents a first protrusion, 10 represents a second protrusion, 11 represents a lower bearing plate, 12 represents a groove, 13 represents a right-angle limit block, 14 represents a recess, 15 represents a cross hollow portion, 16 represents a semiconductor element limit slot, 17 represents a bearing guide plate, and 18 represents a handle.

### DETAILED DESCRIPTION

As shown in the figures, the present invention comprises a housing, wherein a housing base is provided with a semiconductor element limit slot, a heating and cooling semiconductor element is disposed in the semiconductor element limit slot, an upper end of the semiconductor element limit slot is covered by an embedding block limit plate, and an embedding block limit hole is disposed on the embedding block limit plate and corresponds to the semiconductor element limit slot; and a control circuit disposed in the housing base, wherein a control signal output port of the control circuit is connected to a control signal input port of the heating and cooling semiconductor element, and a detection signal input port of the control circuit is connected to a detection signal output port of a temperature sensor that detects the temperature of the heating and cooling semiconductor element.

The heating and cooling semiconductor element is a two-level heating and cooling semiconductor element. By means of the two-level heating and cooling semiconductor element, heating and cooling speeds may further be increased, and heating and cooling processes can be completed in several seconds. A specimen processing time is shortened to the extreme, and is almost negligible.

The semiconductor element limit slot is disposed on the semiconductor element limit plate, and the semiconductor element limit plate is detachably connected to the housing base. The semiconductor element limit slot comprises a strip groove extending from an edge of the semiconductor element limit plate to a central portion, an upper portion of two ends of the groove is a first protrusion facing the central portion, a limit stop is disposed on a lower end of the semiconductor element limit plate on an inner end of the groove, a lower bearing plate is disposed below an inner side of the groove, and two sides of the lower bearing plate are connected to the lower end of the semiconductor element limit plate. An upper portion on an inner side of the first protrusion is a second protrusion facing the central portion. A bearing guide plate is disposed on an opening edge of the housing base where the semiconductor element limit plate is mounted, and corresponds to an initial placement position of a first-level heating and cooling semiconductor element of the two-level heating and cooling semiconductor element.

With the groove disposed, it is convenient to push a semiconductor element inward, and convenient to disassemble and assemble the semiconductor element. The second-level heating and cooling semiconductor element is disposed on a central portion of the first-level heating and cooling semiconductor element and protrudes. The first-level heating and cooling semiconductor element is initially placed on the bearing guide plate, and is pushed forwards into the groove along the bearing guide plate. Then the first-level heating and cooling semiconductor element is further pushed forwards into the lower end of the first protrusion. Finally, a front end of the first-level heating and cooling semiconductor element abuts against the limit stop. A lower end of the first-level heating and cooling semiconductor element is placed on the lower bearing plate, and the first-level heating and cooling semiconductor element is clamped between the first protrusion and the lower bearing plate. The second-level heating and cooling semiconductor element is relatively narrow, and thus is located between first protrusions on two sides. Two sides of the second-level heating and cooling semiconductor element are disposed below second protrusions, and an opening between the second protrusions is a contact opening between an embedding block and a semiconductor element.

The semiconductor element limit plate is detachably connected to the housing base, making it convenient to disassemble and assemble a component.

The semiconductor element limit plate is provided with four semiconductor element limit slots, and centers of the four semiconductor element limit slots form a square when being connected. The embedding block limit plate is provided with four embedding block limit holes corresponding to the semiconductor element limit slots. With multiple semiconductor element limit slots and embedding block limit holes disposed, batch processing of embedding blocks is facilitated.

A central portion of the embedding block limit plate is a cross hollow portion, and a central portion of each edge is provided with an inward recess. With the cross hollow portion disposed, it is convenient to take and place the embedding block limit plate.

In the present invention, a cover plate for tightly pressing a tissue sample embedding block in the embedding block limit hole is further disposed, an upper cover is disposed on an upper end of the housing, one end of the upper cover is axially connected to the housing, and the other end of the upper cover is engaged with the housing.

During use, the embedding block limit plate is first placed on the semiconductor element limit plate, then an embedding cassette (refer to Patent No. 201610159556.4) is placed in the embedding block limit hole, and the embedding block limit hole is covered by the upper cover, so that a lower end cover of the embedding cassette is in close contact with the semiconductor element. By switching anode and cathode of the semiconductor element, switching of a low-temperature surface of the semiconductor element can be controlled. The semiconductor element has a surface with a low temperature (approximately 20 degree Celsius lower than the other surface, wherein another semiconductor element, that is, the two-level heating and cooling semiconductor element, may be further mounted on a cooling surface, and a high-temperature surface of the semiconductor element mounted later has the same temperature as the low-temperature surface of the basic semiconductor element, so that the temperature is further lowered), and the other surface is consistent with an ambient temperature.

A heat sink and a cooling fan are disposed in the housing base and correspond to the heating and cooling semiconductor element, and a control signal input port of the cooling fan is connected to the control signal output port of the control circuit.

After tissue on an embedded label (refer to Patent No. 201610159556.4) is sectioned, the tissue is placed in a label cover (refer to Patent No. 201610159556.4), and the embedded label is inserted downwards into the embedding block limit hole. The heating and cooling semiconductor element is controlled to perform heating, and its anode and cathode are switched after the embedded label is pressed into the tissue, so that cooling makes the embedded label stay in the tissue and they form a whole. The embedding block limit plate is lifted to separate from the semiconductor element limit slot, and the label cover is taken out and placed in a storage cassette.

Before the tissue is sectioned, the embedding cassette is first taken out, heated, and opened, and is adhered on a sectioning apparatus after dispensing adhesive, and then sectioning is performed.

In the present invention, when the heating and cooling semiconductor element is controlled for thawing, the temperature is increased to 40 degree Celsius and maintained for 1 second, the electrodes are reversed for cooling to lower the temperature to 5 degree Celsius and the temperature is maintained for 5 seconds, the embedding block is quickly taken off, and a label side is uncovered for later use.

During resetting and refreezing, the semiconductor element is set to −20 degree Celsius, a 1-cubic-centimeter tissue piece is heated to 60 degree Celsius, after a pause of 8 seconds, the electrodes are reversed, the cooling fan starts for cooling to lower the temperature to −30 degree Celsius and the temperature is maintained for 10 seconds, after a pause of 5 seconds, the electrodes are reversed for heating to increase the temperature to 5 degree Celsius, the operation stops, and the sample is removed quickly.

The foregoing technical parameters are obtained by the inventor through long-term systematic experiment and repeated parameter fumble. In the operation manner, a plurality of embedding blocks can quickly enter an operating state within 30 seconds, and a plurality of embedding block labels after use can be reset and frozen within 1 minute.

The control circuit comprises a CPU, a power conversion part, a system control part, a memory, a system feedback part, a display part, a Bluetooth part, and a heat-dissipation control part. A control signal output port of the CPU is connected to a control signal input port of the system control part and a control signal input port of the heat-dissipation control part, respectively. A detection signal input port of the CPU is connected to a detection signal output port of the system feedback part. A signal transmission port of the CPU is connected to a signal transmission port of the memory, a signal transmission port of the display part, and a signal transmission port of the Bluetooth part, respectively. The display part is disposed in the front of the housing.

A power supply output port of the power conversion part is connected to a power port of the CPU, a power port of the system control part, a power port of the memory, a power port of the system feedback part, a power port of the display part, a power port of the alarm part, and a power port of the heat-dissipation control part, respectively.

Multiple user-defined modes can be set according to actual needs.

The CPU is an STM32F103RBT6 chip U1. A pin 5 of U1 is connected to one end of a resistor R1, one end of a crystal oscillator X1, and one end of a capacitor C1, respectively, a pin 6 of U1 is connected to the other end of the resistor R1, the other end of the crystal oscillator X1, and one end of a capacitor C2, respectively, the other end of the capacitor C1 is connected to a ground wire, the other end of the capacitor C2, and one end of a capacitor C3, respectively, the other end of the capacitor C3 is connected to one end of a resistor R2 and a pin 7 of U1, respectively, and the other end of the resistor R2 is connected to a 3.3-V power supply. A pin 60 of U1 is grounded by using a resistor R3, a pin 38 of U1 is connected to a cathode of a light emitting diode DS1, an anode of the light emitting diode DS1 is connected to the 3.3-V power supply by using a resistor RD1, a pin 37 of U1 is connected to a cathode of a light emitting diode DS0, and an anode of the light emitting diode DS0 is connected to the 3.3-V power supply by using a resistor RD2.

The power conversion part comprises an LM2596S-5.0 chip U2 and an RT9167A-3.3 chip U3. A pin 1 of U2 is connected to a cathode of a diode D1 and an anode of a capacitor C8, respectively, an anode of a diode D1 is connected to a 15-V power supply and an anode of a capacitor C12, respectively, and a cathode of the capacitor C12 is connected to a cathode of the capacitor C8 and a ground wire, respectively. A pin 2 of U2 is connected to a cathode of a diode D2 and one end of an inductor L1, respectively, an anode of the diode D2 is grounded, the other end of the inductor L1 is connected to an anode of a capacitor C9, a pin 4 of U2, an anode of a capacitor C10, an anode of a capacitor C11, and a power supply VCC, respectively, and pins 3 and 5 of U2 are grounded.

Pins 1 and 3 of U3 are connected to the power supply VCC, a pin 2 of U3 is grounded, a pin 4 of U3 is grounded by using a capacitor C17, a pin 5 of U3 is connected to one end of a capacitor C18, an anode of a capacitor C19, an anode of a capacitor C20, and the 3.3-V power supply, respectively, and the other end of the capacitor C18 is connected to a cathode of the capacitor C19, the cathode of the capacitor C20, and a ground wire, respectively.

The system control part comprises an IRF740 chip MOS2, an IRF740 chip MOS1, an IRF740 chip MOS3, an IRF740 chip MOS4, a relay SRD1, a relay SRD2, a relay SRD3, a relay SRD4, and a ULN2003 chip U4. A pin 5 of the relay SRD1 is connected to GND_P1, a pin 4 of the relay SRD1 is connected to 15V_P1, a pin 1 of the relay SRD1 is connected to the power supply VCC, a pin 3 of the relay SRD1 is connected to a pin 14 of U4, and a pin 2 of the relay SRD1 is connected to a pin of the first-level heating and cooling semiconductor element of the two-level heating and cooling semiconductor element.

A pin 5 of the relay SRD2 is connected to GND_P1, a pin 4 of the relay SRD2 is connected to 15V_P1, a pin 1 of the relay SRD2 is connected to the power supply VCC, a pin 3 of the relay SRD2 is connected to a pin 13 of U4, and a pin 2 of the relay SRD2 is connected to another pin of the first-level heating and cooling semiconductor element of the two-level heating and cooling semiconductor element.

A pin 5 of the relay SRD3 is connected to GND_P2, a pin 4 of the relay SRD3 is connected to 15V_P2, a pin 1 of the relay SRD3 is connected to the power supply VCC, a pin 3 of the relay SRD3 is connected to a pin 16 of U4, and a pin 2 of the relay SRD3 is connected to a pin of the second-level heating and cooling semiconductor element of the two-level heating and cooling semiconductor element.

A pin 5 of the relay SRD4 is connected to GND_P2, a pin 4 of the relay SRD4 is connected to 15V_P2, a pin 1 of the relay SRD4 is connected to the power supply VCC, a pin 3 of the relay SRD4 is connected to a pin 15 of U4, and a pin 2 of the relay SRD4 is connected to another pin of the second-level heating and cooling semiconductor element of the two-level heating and cooling semiconductor element.

The 15-V power supply is connected to 15V_P1 by using a thermal protection switch PROTECT1, and the 15-V power supply is connected to 15V_P2 by using a thermal protection switch PROTECT2.

A pin 2 of MOS2 is connected to GND_P1 and a pin 2 of MOS1, respectively, a pin 1 of MOS2 is connected to a pin 9 of U1, a pin 1 of MOS1, and one end of a resistor R7, respectively, the other end of the resistor R7 is connected to the 15-V power supply, and a pin 3 of MOS1 and a pin 3 of MOS2 are grounded.

A pin 2 of MOS3 is separately connected to GND_P2 and a pin 2 of MOS4, a pin 1 of MOS3 is connected to a pin 8 of U1, a pin 1 of MOS4, and one end of a resistor R6, respectively, the other end of the resistor R6 is connected to the 15-V power supply, and a pin 3 of MOS4 and a pin 3 of MOS3 are grounded.

Pins 1, 2, 3, 4, and 5 of U4 are correspondingly connected to pins 54, 53, 52, 51, and 50 of U1, respectively, and a pin 12 of U4 is connected to a buzzer BUZ.

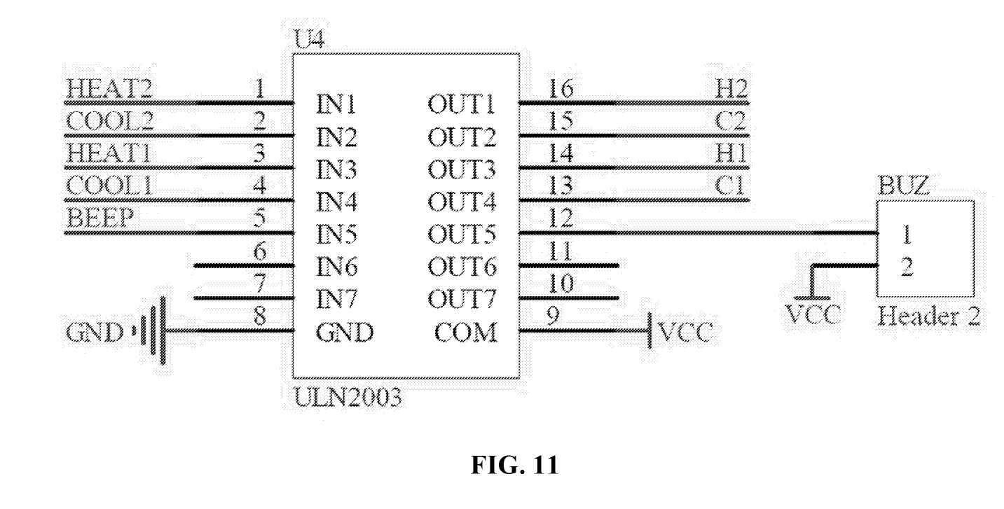

As shown in FIGS. 9, 10, and 11, G1 and G2 are gate control signals of MOS1 and MOS2, and MOS3 and MOS4. When G1 has a voltage of 15 V, MOS1 and MOS2 are in an on state. When G1 is 0 V, MOS1 and MOS2 are in a cut-off state. When the relay is closed, G1 can be used to adjust load power by means of pulse width modulation (PWM). When G1 is at a low level (that is, MOS1 and MOS2 are in a cut-off state) to control on/off of the relay, and after the on/off of the relay is completed, G1 is controlled to be 15-V on. In this way, no sparks are caused by contact the moment the relay is closed or opened, and the service life of the relay is greatly prolonged.

BUZ is a buzzer. In case of system operation abnormality (comprising a fault of the temperature sensor, a fault of the fan, a fault of the CPU, and a communication fault of a liquid crystal screen), the buzzer sounds intermittently, and the system stops.

The PROTECT interface is a thermal protection switch interface. The thermal protection switch may be a 100° C./10 A normally closed protection switch, which is connected in serial in a load operation power loop, and functions as follows: when the system is out of control and load still operates and emits heat, and when the temperature exceeds 100° C., the thermal protection switch is switched off to cut off power supply, thereby avoiding a danger caused by overheat.

The memory is a W25X16 chip U5. A pin 1 of U5 is connected to a pin 20 of U1, a pin 2 of U5 is connected to a pin 22 of U1, a pin 6 of U5 is connected to a pin 21 of U1, and a pin 5 of U5 is connected to a pin 23 of U1.

The system feedback part comprises a resistor R10, a resistor R11, and a resistor R13. One end of the resistor R10 is connected to one end of the resistor R11 and one end of the resistor R13, respectively. The other end of the resistor R10 is connected to a temperature sensor that detects the temperature of the first-level heating and cooling semiconductor element, a pin 14 of U1, and one end of the capacitor C13, respectively. The other end of the capacitor C13 is grounded.

The other end of the resistor R11 is connected to a temperature sensor that detects the temperature of the second-level heating and cooling semiconductor element, a pin 15 of U1, and one end of a capacitor C14, respectively, and the other end of the capacitor C4 is grounded.

The other end of the resistor R13 is connected to a temperature sensor that detects the temperature of the heat sink, a pin 24 of U1, and one end of a capacitor C15, respectively, and the other end of the capacitor C15 is grounded.

The resistor R10, the resistor R11, and the resistor R13 are voltage divider resistors that detect the temperature according to changes in divided voltage values.

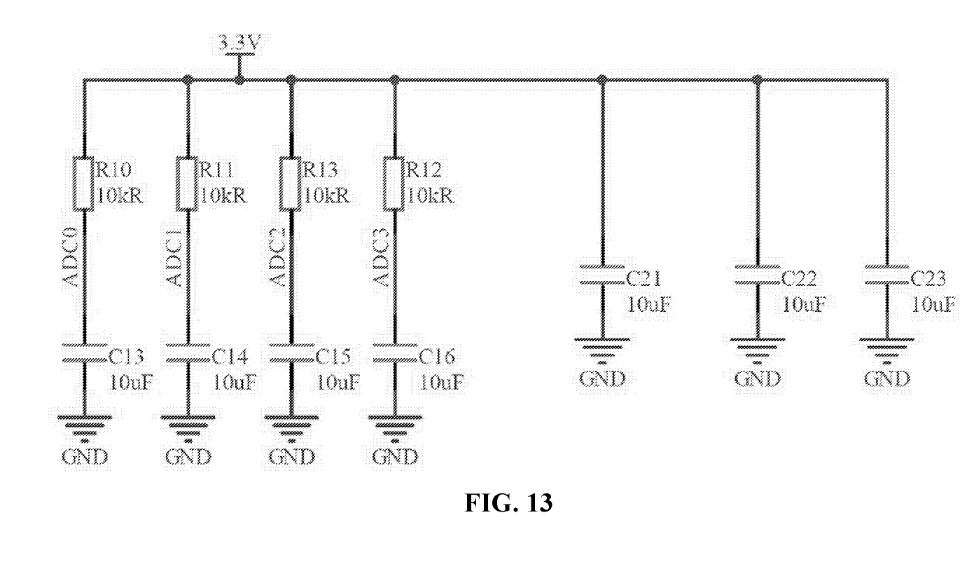

As shown in FIGS. 13 and 14, P5 to P8 are connected to temperature sensors, where P5, P6, and P7 are, respectively connected to temperature sensors of two coolers and the temperature sensor of the heat sink, and P8 is a reserved interface.

P5 and P6 measure temperatures of the two coolers and feed back the temperatures to the CPU, and the CPU adjusts operating states of the coolers according to the temperatures that are fed back. P7 measures the temperature of the heat sink, and the CPU adjusts an operating state of the cooling fan according to the temperature that is fed back.

The display part comprises an MAX232 chip U6. A pin 1 and a pin 3 of U6 are connected by using a capacitor C4, a pin 4 and a pin 5 of U6 are connected by using a capacitor C5, a pin 11 of U6 is connected to a pin 42 of U1, a pin 12 of U6 is connected to a pin 43 of U1, a pin 13 of U6 is connected to an RS232RXD pin of an LCD, and a pin 14 of U6 is connected to an RS232TXD pin of the LCD.

The LCD displays a human-computer interaction interface. Displayed content may comprise running state control (comprising control over the temperatures of the coolers and duration) of the entire system, real-time data display (comprising the temperatures of the coolers and the duration), mode options (comprising options of the temperatures of the coolers and the duration), and help (comprising a specification, a company profile, and the like).

The Bluetooth part is an HC-08 Bluetooth module U7, and pins 1 and 2 of U7 are correspondingly connected to pins 17 and 16 of U1. A corresponding APP may be set for wireless communication.

The heat-dissipation control part comprises an AO3401 chip MOS5. A pin 1 of MOS5 is connected to one end of a resistor R8 and the 15-V power supply, respectively, the other end of the resistor R8 is connected to one end of a resistor R9 and a pin 2 of MOS5, respectively, a pin 3 of MOS5 is connected to a cooling fan, and the other end of the resistor R9 is connected to the control signal output port of the CPU.

The heating and cooling semiconductor element is an FPK2-15828NC heating and cooling semiconductor element.

Right-angle limit blocks are disposed at four corners of the semiconductor element limit plate, and the right-angle limit blocks correspond to four corners of the embedding block limit plate, which facilitates accurate positioning of the embedding block limit plate.

A handle is disposed on an upper end of the cover plate, facilitating handhold.

It may be understood that, the foregoing specific description of the present invention is intended for illustration only, and not for limiting the technical solutions described in the embodiments of the present invention. Persons of ordinary skill in the art should understand that, modifications or equivalent replacements may still be made to the present invention to achieve the same technical effects; as long as such modifications and equivalent replacements meet use requirements, they all fall within the protection scope of the present invention.

1. A temperature control system for cryogenic tissue embedding, comprising a heating and cooling semiconductor element and a control circuit, wherein a control signal output port of the control circuit is connected to a control signal input port of the heating and cooling semiconductor element, and a detection signal input port of the control circuit is connected to a detection signal output port of a temperature sensor that detects the temperature of the heating and cooling semiconductor element;
the control circuit comprises a CPU, a power conversion part, a system control part, a memory, a system feedback part, a display part, a Bluetooth part, and a heat-dissipation control part, wherein a control signal output port of the CPU is connected to a control signal input port of the system control part and a control signal input port of the heat-dissipation control part, respectively; a detection signal input port of the CPU is connected to a detection signal output port of the system feedback part; a signal transmission port of the CPU is connected to a signal transmission port of the memory, a signal transmission port of the display part, and a signal transmission port of the Bluetooth part, respectively; and the display part is disposed in the front of the housing; and
a power supply output port of the power conversion part is connected to a power port of the CPU, a power port of the system control part, a power port of the memory, a power port of the system feedback part, a power port of the display part, a power port of an alarm part, and a power port of the heat-dissipation control part, respectively.

2. The temperature control system for cryogenic tissue embedding of claim 1, wherein the heating and cooling semiconductor element is a two-level heating and cooling semiconductor element.

3. The temperature control system for cryogenic tissue embedding of claim 2, wherein the CPU is an STM32F103RBT6 chip U1, a pin 5 of U1 is connected to one end of a resistor R1, one end of a crystal oscillator X1, and one end of a capacitor C1, respectively, a pin 6 of U1 is connected to the other end of the resistor R1, the other end of the crystal oscillator X1, and one end of a capacitor C2, respectively, the other end of the capacitor C1 is connected to a ground wire, the other end of the capacitor C2, and one end of a capacitor C3, respectively, the other end of the capacitor C3 is connected to one end of a resistor R2 and a pin 7 of U1, respectively, and the other end of the resistor R2 is connected to a 3.3-V power supply; and a pin 60 of U1 is grounded by using a resistor R3, a pin 38 of U1 is connected to a cathode of a light emitting diode DS1, an anode of the light emitting diode DS1 is connected to the 3.3-V power supply by using a resistor RD1, a pin 37 of U1 is connected to a cathode of a light emitting diode DS0, and an anode of the light emitting diode DS0 is connected to the 3.3-V power supply by using a resistor RD2.

4. The temperature control system for cryogenic tissue embedding of claim 1, wherein the power conversion part comprises an LM2596S-5.0 chip U2 and an RT9167A-3.3 chip U3, a pin 1 of U2 is connected to a cathode of a diode D1 and an anode of a capacitor C8, respectively, an anode of the diode D1 is connected to a 15-V power supply and an anode of a capacitor C12, respectively, and a cathode of the capacitor C12 is connected to a cathode of the capacitor C8 and a ground wire, respectively; a pin 2 of U2 is connected to a cathode of a diode D2 and one end of an inductor L1, respectively, an anode of the diode D2 is grounded, the other end of the inductor L1 is connected to an anode of a capacitor C9, a pin 4 of U2, an anode of a capacitor C10, an anode of a capacitor C11, and a power supply VCC, respectively, and pins 3 and 5 of U2 are grounded; and
pins 1 and 3 of U3 are connected to the power supply VCC, a pin 2 of U3 is grounded, a pin 4 of U3 is grounded by using a capacitor C17, a pin 5 of U3 is connected to one end of a capacitor C18, an anode of a capacitor C19, an anode of a capacitor C20, and the 3.3-V power supply, respectively, and the other end of the capacitor C18 is connected to a cathode of the capacitor C19, the cathode of the capacitor C20, and a ground wire, respectively.

5. The temperature control system for cryogenic tissue embedding of claim 3, wherein the system control part comprises an IRF740 chip MOS2, an IRF740 chip MOS1, an IRF740 chip MOS3, an IRF740 chip MOS4, a relay SRD1, a relay SRD2, a relay SRD3, a relay SRD4, and a ULN2003 chip U4, a pin 5 of the relay SRD1 is connected to GND_P1, a pin 4 of the relay SRD1 is connected to 15V_P1, a pin 1 of the relay SRD1 is connected to the power supply VCC, a pin 3 of the relay SRD1 is connected to a pin 14 of U4, and a pin 2 of the relay SRD1 is connected to a pin of the first-level heating and cooling semiconductor element of the two-level heating and cooling semiconductor element;
a pin 5 of the relay SRD2 is connected to GND_P1, a pin 4 of the relay SRD2 is connected to 15V_P1, a pin 1 of the relay SRD2 is connected to the power supply VCC, a pin 3 of the relay SRD2 is connected to a pin 13 of U4, and a pin 2 of the relay SRD2 is connected to another pin of the first-level heating and cooling semiconductor element of the two-level heating and cooling semiconductor element;
a pin 5 of the relay SRD3 is connected to GND_P2, a pin 4 of the relay SRD3 is connected to 15V_P2, a pin 1 of the relay SRD3 is connected to the power supply VCC, a pin 3 of the relay SRD3 is connected to a pin 16 of U4, and a pin 2 of the relay SRD3 is connected to a pin of a second-level heating and cooling semiconductor element of the two-level heating and cooling semiconductor element;
a pin 5 of the relay SRD4 is connected to GND_P2, a pin 4 of the relay SRD4 is connected to 15V_P2, a pin 1 of the relay SRD4 is connected to the power supply VCC, a pin 3 of the relay SRD4 is connected to a pin 15 of U4, and a pin 2 of the relay SRD4 is connected to another pin of the second-level heating and cooling semiconductor element of the two-level heating and cooling semiconductor element;
the 15-V power supply is connected to 15V_P1 by using a thermal protection switch PROTECT1, and the 15-V power supply is connected to 15V_P2 by using a thermal protection switch PROTECT2;
a pin 2 of MOS2 is connected to GND_P1 and a pin 2 of MOS1, respectively, a pin 1 of MOS2 is connected to a pin 9 of U1, a pin 1 of MOS1, and one end of a resistor R7, respectively, the other end of the resistor R7 is connected to the 15-V power supply, and a pin 3 of MOS1 and a pin 3 of MOS2 are grounded;
a pin 2 of MOS3 is connected to GND_P2 and a pin 2 of MOS4, respectively, a pin 1 of MOS3 is connected to a pin 8 of U1, a pin 1 of MOS4, and one end of a resistor R6, respectively, the other end of the resistor R6 is connected to the 15-V power supply, and a pin 3 of MOS4 and a pin 3 of MOS3 are grounded; and
pins 1, 2, 3, 4, and 5 of U4 are correspondingly connected to pins 54, 53, 52, 51, and 50 of U1, respectively, and a pin 12 of U4 is connected to a buzzer BUZ.

6. The temperature control system for cryogenic tissue embedding of claim 3, wherein the system feedback part comprises a resistor R10, a resistor R11, and a resistor R13, one end of the resistor R10 is connected to one end of the resistor R11 and one end of the resistor R13, respectively, the other end of the resistor R10 is connected to a temperature sensor that detects the temperature of the first-level heating and cooling semiconductor element, a pin 14 of U1, and one end of the capacitor C13, respectively, and the other end of the capacitor C13 is grounded;
the other end of the resistor R11 is connected to a temperature sensor that detects the temperature of the second-level heating and cooling semiconductor element, a pin 15 of U1, and one end of a capacitor C14, respectively, and the other end of the capacitor C4 is grounded; and
the other end of the resistor R13 is connected to a temperature sensor that detects the temperature of a heat sink, a pin 24 of U1, and one end of a capacitor C15, respectively, and the other end of the capacitor C15 is grounded.

7. The temperature control system for cryogenic tissue embedding of claim 3, wherein the display part comprises an MAX232 chip U6, a pin 1 and a pin 3 of U6 are connected by using a capacitor C4, a pin 4 and a pin 5 of U6 are connected by using a capacitor C5, a pin 11 of U6 is connected to a pin 42 of U1, a pin 12 of U6 is connected to a pin 43 of U1, a pin 13 of U6 is connected to an RS232RXD pin of an LCD, and a pin 14 of U6 is connected to an RS232TXD pin of the LCD.

8. The temperature control system for cryogenic tissue embedding of claim 1, wherein the heat-dissipation control part comprises an AO3401 chip MOS5, a pin 1 of MOS5 is connected to one end of a resistor R8 and the 15-V power supply, respectively, the other end of the resistor R8 is connected to one end of a resistor R9 and a pin 2 of MOS5, respectively, a pin 3 of MOS5 is connected to a cooling fan, and the other end of the resistor R9 is connected to the control signal output port of the CPU.

9. The temperature control system for cryogenic tissue embedding of claim 3, wherein the memory is a W25X16 chip U5, a pin 1 of U5 is connected to a pin 20 of U1, a pin 2 of U5 is connected to a pin 22 of U1, a pin 6 of U5 is connected to a pin 21 of U1, and a pin 5 of U5 is connected to a pin 23 of U1.

10. The temperature control system for cryogenic tissue embedding of claim 3, wherein the Bluetooth part is an HC-08 Bluetooth module U7, and pins 1 and 2 of U7 are correspondingly connected to pins 17 and 16 of U1.
